(19) United States
(12) Patent Application Publication
(10) Pub. No.: US 2016/0312107 A1
(43) Pub. Date: Oct. 27, 2016

(54) METHOD FOR FRACTURING ROCKS

(71) Applicant: TOTAL SA, Courbevoie (FR)

(72) Inventor: Jean-François Leon, Pau (FR)

(21) Appl. No.: 15/102,196

(22) PCT Filed: Oct. 10, 2014
(86) PCT No.: PCT/FR2014/052578

§ 371 Date: Jun. 6, 2016

(30) Foreign Application Priority Data
Dec. 6, 2013 (FR) 13 62262

(51) Int. Cl. C09K 8/64; E21B 43/26; E21B 43/16; C09K 8/70

(52) U.S. Cl. CPC C09K 8/64; C09K 8/70; E21B 43/26; E21B 43/164

(57) ABSTRACT

The invention relates to a method for fracturing underground rock. The method involves injecting a fracturing fluid into a well. Said fluid comprises at least 30% volume of carbon dioxide in liquid form, at least 20 volume % of carbon dioxide in a solid form, and at least 10% volume of liquefied hydrocarbon gas.

### RELATED APPLICATIONS

The present application is a National Phase entry of PCT Application No. PCT/FR2014/052578, filed Oct. 10, 2014, which claims priority from FR Patent Application 13 62262, filed Dec. 6, 2013, said applications being hereby incorporated by reference herein in their entirety.

### FIELD OF THE INVENTION

This invention relates to the field of fracturing underground rock, in particular using alternative methods to hydraulic fracturing.

### BACKGROUND OF THE INVENTION

When fracturing rocks using conventional hydraulic fracturing methods, the pressure of the fracturing fluid (e.g. 200,000 to 600,000 hPa, i.e. two hundred to six hundred times the atmospheric pressure, typically in excess of 400,000 hPa for depths greater than 3,000 m) must exceed the pressure of the rock's natural stresses in order to be able to fracture the rock (or at least, exceed the least principal of the three directional pressure components along the axes \vec{x}, \vec{y}, and \vec{z} of the natural stresses).

The stress field is very often anisotropic, i.e. the stress in one direction greatly exceeds the stresses in the other 2 directions.

Therefore, although the least principal stress can be easily exceeded by the pressure of the fracturing fluid, it may be difficult (or even impossible) to have a pressure of the fracturing fluid that exceeds the second greatest principal stress (intermediate stress) applied to the rock: therefore, in reservoirs where the stresses are significantly anisotropic, stimulation via hydraulic fracturing results in a single fracture, along a single plane that is perpendicular to the direction of the least principal stress. The energy provided by the fluid will be dissipated by the gradual propagation of the fracture continuing in the same direction, and the pressure required to exceed the intermediate principal stress will not be reached.

It is therefore difficult to produce “isotropic” fracturing throughout the volume of the rock (e.g. obtain a complex network of fractures).

Certain solutions have been implemented using a fracturing fluid composed of a liquefied gas (for example CO₂ which remains liquid up to +31° C. at fracturing pressures) and liquid hydrocarbons (e.g. document US 2009/0260828).

Other methods propose the use of liquid helium or liquid nitrogen. Nonetheless, these methods can face significant difficulties with regard to their practical implementation due to their very low liquefaction temperature at fracturing pressures.

Nonetheless, when injecting these fluids or these pure liquid gases into the well, they can quickly heat up under the effect of the existing underground temperatures and the liquefied gas can quickly heat up and evaporate.

There is therefore a need to improve isotropic fracturing in underground environments subject to anisotropic stresses. This invention improves this situation.

### SUMMARY OF THE INVENTION

This invention proposes to locally reduce the natural stresses applied to the rocks by the effective cooling of the latter, thus providing the possibility of propagating the fracture over multiple planes.

This invention thus relates to a method for fracturing underground rock. The method involves injecting a fracturing fluid into a well.

The fluid comprises:

at least 30 volume % of carbon dioxide in a liquid form,

at least 20 volume % of carbon dioxide in a solid form, and

at least 10 volume % of liquefied hydrocarbon gas.

The fluid can be injected at pressures in excess of the least principal stress of the three underground principal stresses.

Advantageously, the method can further comprise:

the control and maintenance of the temperature of the fluid injected at the wellhead at a temperature below −50° C.

For example, said temperature can be −60° C. for the liquid phase of the fluid.

Indeed, in order to accentuate the desired fracturing effect, the temperature of the fluid should ideally be as low as possible, while ensuring that the liquid carbon dioxide remains in liquid form at the desired fracturing pressures. Therefore, if the temperature of the liquid-solid phase change of CO₂ is T_{liq-sol} for these pressures, the temperature of the fluid can be maintained at a temperature that is slightly lower than this temperature T_{liq-sol} (by 1 to 10° C.), in order to improve fracturing.

Moreover, the addition of liquefied hydrocarbon gas can enable the solid-liquid CO₂ phase change temperature to be lowered (anti-freeze effect), thus obtaining a fluid containing liquid and solid CO₂ stable at temperatures nearing the conventional melting point of CO₂.

The temperature of the liquid phase of the fluid can therefore be less than T_{liq-sol} as long as the liquid phase remains liquid.

Moreover, the proportion by volume of carbon dioxide in solid form can be adjusted so that the fluid injected has a density of greater than 1,200 kg/m³.

The density of solid carbon dioxide is 1,562 kg/m³ at a temperature of −78.5° C. and at a pressure of 1,000 hPa (or around 1 bar).

Therefore, by gradually increasing the volume of solid carbon dioxide in the fluid (for example by replacing the liquid carbon dioxide by the same quantity of solid carbon dioxide), a proportion by volume can be obtained that exceeds this threshold of 1,200 kg/m³.

A high fluid density increases the hydrostatic effect of the fluid column in the well on the fluid pressure within the fracturing zone, thus reducing the energy required for pumping and pressurising the fluid to be injected at the surface.

The proportion by volume of carbon dioxide in solid form, and/or, whereby the carbon dioxide in solid form is in the form of a block, at least one dimension of said blocks can be adjusted so that the fluid has a dynamic viscosity of greater than 50 mPa·s.

This high viscosity can enable the fluid to effectively carry the propping agent (e.g. silica sand or ceramic beads).

By increasing the proportion by volume of the solid carbon dioxide in the fluid, the overall dynamic viscosity of the fluid at a given temperature can often be increased. Moreover, if the carbon dioxide in solid form is in the form of a block/bead/particle/pebble, the dimensions of these blocks can experimentally influence viscosity. Furthermore, if the proportion by volume of these blocks increases linearly in the fluid, the viscosity can be increased exponentially.

A gelling agent can also be added to the fluid to obtain the desired viscosity.

Advantageously, the fluid can comprise:

50 volume % of carbon dioxide in a liquid form,

25 volume % of carbon dioxide in a solid form, and

25 volume % of liquefied hydrocarbon gas.

Other characteristics and advantages of the invention will be discovered after reading the following description. This is purely for illustrative purposes and must be read using the appended figures, in which:

### BRIEF DESCRIPTION OF THE FIGURE

FIG. 1 illustrates one possible example of fracturing in one embodiment of the invention;

### DETAILED DESCRIPTION OF THE FIGURE

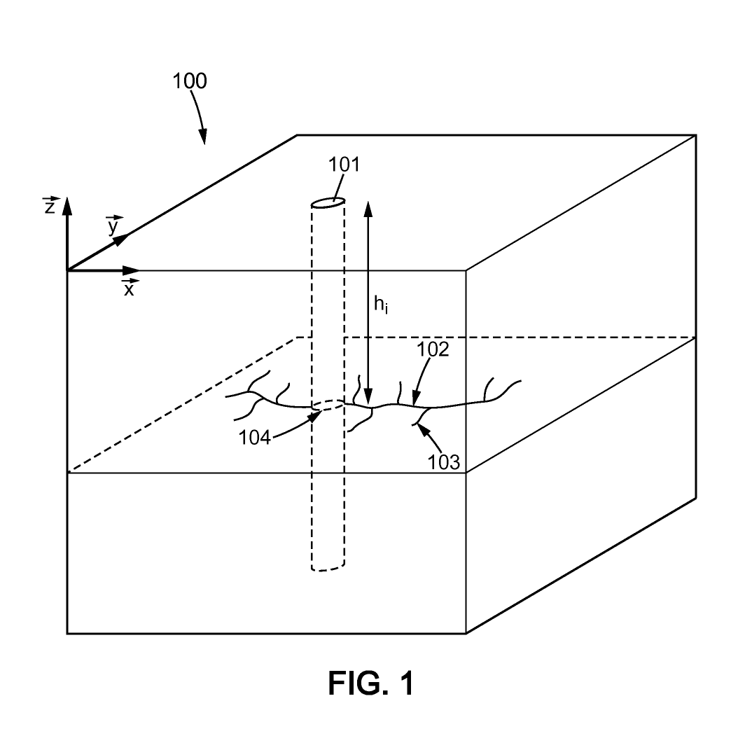

FIG. 1 shows a vertical well 101 drilled underground (represented by the cube 100).

This well comprises a well completion 104 designed for the injection of fracturing fluid into the ground.

If the ground is locally stressed in an anisotropic manner (e.g. the stress pressure in the \vec{x} direction is greater than the stress pressure in the \vec{y} direction), any fracturing will tend to generate fractures 102 in a direction perpendicular to the direction of least stress (i.e. fractures in the \vec{x} direction).

In order to produce fractures 103 in a direction parallel to the direction of least stress (i.e. \vec{y}), the stress in the different directions can be advantageously reduced.

The injection of a cold liquid/gas during fracturing could make the rock contract, thus resulting in the overall reduction of the stresses applied to the rock. This effect is known as the “thermoelastic” effect of the rock.

Fracturing is therefore able to propagate in a direction that is perpendicular to the initial direction (bifurcation).

Although the injection of any gas/liquid can produce this effect, not all possibilities are preferred due to their inherent drawbacks/restrictions (as stipulated hereinabove).

The preferred fracturing fluid is a fluid containing liquid carbon dioxide (CO₂), solid carbon dioxide (or carbon dioxide snow) and liquid hydrocarbons (at the targeted fracturing pressures).

This fluid is advantageously at a temperature nearing −60° C.

For the purposes of illustration, the fluid can comprise (by volume) 25% solid CO₂, 50% liquid CO₂ and 25% liquefied hydrocarbon gas. This fluid is mostly liquid for pressures exceeding 40,000 hPa and for a temperature of −60° C.

The use of solid CO₂ in the fracturing fluid can significantly increase the “heat capacity” or “thermal capacity” of the fluid in order to maintain a large difference in temperature between the fluid and the rock when pumping in the well, and thus amplify the thermal fracturing effect. The heat capacity of the fluid by volume can therefore be substantially increased, allowing the heat to be easily transferred from the fluid to the rock.

The solid CO₂ can thus absorb the heat received by the injection fluid during its descent or in the formation, to an extent limited by its melting power.

The size or shape of the blocks/particles of solid CO₂ can therefore be adapted to guarantee a sufficiently large exchange surface between the solid CO₂ and the liquid to progressively absorb the heat as it is captured by the injection fluid.

As long as the injection fluid retains a portion of solid CO₂, the injection fluid can absorb the heat without the fluid rising in temperature.

The presence of solid CO₂ therefore delays the time at which the temperature of the injection fluid substantially rises, resulting in significant modifications to the fluid's properties (density, viscosity).

Finally, when this fluid heats up, the liquid CO₂ can become supercritical and take up a large amount of space; the expansion of the fluid can contribute to fracturing.

Moreover, the use of solid CO₂ can allow the density of the fluid to be increased, thus benefiting from a greater hydrostatic pressure at the well completion 104. This density can be adjusted to suit needs by adjusting the proportion by volume or density of the solid CO₂ in the fluid. For the pressures and temperatures considered, the density of the fluid can therefore be greater than that of water (or of a fluid containing helium or nitrogen), creating a significant hydrostatic column in the well (of height hᵢ).

Finally, the use of solid CO₂ can allow the viscosity of the fluid to be increased, thus easing carriage of the propping agent which is useful for the effective stimulation of the ground by fracturing. This viscosity can be adjusted to suit needs by adjusting the proportion by volume or density of the solid CO₂ in the fluid and/or by modifying the size of the particles/pebbles of solid CO₂ in the fluid. If the viscosity of the liquid CO₂ is low (0.2 mPa·s), the addition of solid CO₂ and hydrocarbons can substantially increase the viscosity of the fluid.

In one embodiment, the liquefied hydrocarbon gas can be LNG (liquefied natural gas), or LPG (liquefied petroleum gas).

The addition of liquefied hydrocarbon gas can enable the solid-liquid CO₂ phase change temperature (melting point) to be lowered, thus obtaining a fluid containing liquid and solid CO₂ stable at temperatures nearing the conventional melting point of CO₂.

This fluid is not harmful to the rock and the CO₂ has a tendency to replace the methane potentially trapped in the rock.

Of course, this invention is not limited to the embodiments described above for the purposes of illustration; it extends to other alternatives.

Other embodiments are possible.

For example, the well 101 in FIG. 1 can be an inclined well or a horizontal well.

1. A method for fracturing underground rock, the method comprising:
injecting a fracturing fluid into a well, wherein the fluid comprises:
at least 30 volume % of carbon dioxide in a liquid form,
at least 20 volume % of carbon dioxide in a solid form, and
at least 10 volume % of liquefied hydrocarbon gas.

2. The method according to claim 1, wherein the method further comprises:
controlling and maintaining of the temperature of the fluid injected at the wellhead at a temperature below −50° C.

3. The method according to claim 1, wherein the proportion by volume of carbon dioxide in solid form is adjusted so that the fluid has a density of greater than 1,200 kg/m³.

4. The method according to claim 1, wherein the proportion by volume of carbon dioxide in solid form is adjusted so that the fluid has a dynamic viscosity of greater than 50 mPa·s.

5. The method according to claim 1, wherein the carbon dioxide in solid form is in the form of a block, at least one dimension of said blocks is adjusted so that the fluid has a dynamic viscosity of greater than 50 mPa·s.

6. The method according to claim 1, wherein the fluid comprises:
50 volume % of carbon dioxide in a liquid form,
25 volume % of carbon dioxide in a solid form, and
25 volume % of liquefied hydrocarbon gas.
